(19) United States
(12) Patent Application Publication
(10) Pub. No.: US 2021/0020002 A1
(43) Pub. Date: Jan. 21, 2021

(54) marCart

(71) Applicant: Mario Michel, Roosevelt, NY (US)

(72) Inventor: Mario Michel, Roosevelt, NY (US)

(21) Appl. No.: 16/858,184

(22) Filed: Jun. 17, 2020

(51) Int. Cl. G07G 1/00; G08B 13/24; B62B 3/14; B62B 5/00

(52) U.S. Cl. CPC G07G 1/0009; G07G 1/0045; G08B 13/246; B60N 3/101; B62B 3/1436; B62B 3/1444; B62B 5/0006; B62B 3/1404

(57) ABSTRACT

A personal electronic shopping cart (marCart) having a portable scanning device to eliminate the common practice involving picking up a shopping cart from the store to load and unload then reload before exiting the store then unload again into your vehicle. The cart can be owned if purchased from its manufacturers or rented from a marCart Docking Station. The marCart can be hauled from behind any vehicle or humanly operated with its battery-powered mechanism. The marCart also come with Wireless Self Checkout Register to be installed inside of the store for check out purposes. The marCart Wireless Self Checkout Register connect to the marCart. The marCart size is designed in compliances with guidelines established by proper authority. For many years, people make the trip to the store to shop for many different items; groceries, clothes, etc . . . one common practice involve picking up a shopping cart, go inside of the store, pick items then place them in the shopping cart then go to the register remove every items, pay for them then place them back in the cart, push it outside the store unload then place in the vehicle. This old process is an inconvenient and tedious way to shop. The marCart is invented to give a better option to shoppers to make shopping more convenient and easier.

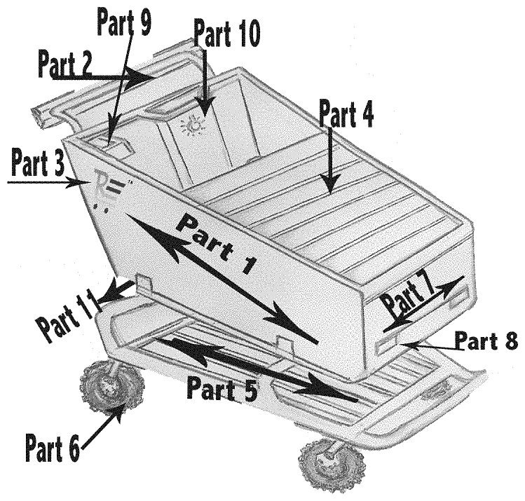

### marCart INVENTION

The marCart invention differs from other shopping carts because of its electronic operation, its mechanical and physical features. It also provides more convenience to shoppers.

### marCart BACKGROUND

The use of shopping carts provides convenience to shoppers at various stores. Shoppers usually push it inside of the establishments like, supermarkets, groceries etc. shoppers pick items within the stores then perform the loading and unloading process until check out using the shopping cart. Usually, it is picked from the store parking lot then return after the shopping process is completed. The present invention eliminates the tedious process of loading and unloading, which is done on at least four occasions during a single shopping visit to the stores. With marCart this process is done once at the store then unloading at final destination. Present day shopping carts do not have an electronic system to self scan and self check out. Differently, marCart provides an electronic built in self-checkout to make shopping more convenient.

### BRIEF DESCRIPTION OF THE DRAWINGS

### Part 1

The storage compartment inside of the marCart

### Part 2

The module Controller attached to the rear pushing/pulling bar

### Part 3

The marCart Logo

Part 4

The top cover, sliding front to rear to close and rear to front to open

### Part 5

The Bottom of the marCart: extra storage, a battery compartment, extension front and rear to provide a standing/seating area for children (weight restrictions to be determined by manufacturers)

### Part 6

The 4 wheels of the marCart

### Part 7

Anti-shoplifters Alert system (Visual and audio) also serves as a reflector.

### Part 8

Brake lights also part of safety features of the marCart

### Part 9

The Scanning device (Portable scanning device with holder attached to the marCart)

### Part 10

marCart cooling system control

### Part 11

Hauling system (use to pull the marCart from behind a vehicle. The marCart come with safety features in compliance with regulations in put in place by proper authority.

1. marCart is a personal electronic shopping cart shoppers use when shopping at different commercial establishments like, super markets, pharmacy, etc . . . A marCart Docking Station will be made available within the store parking lot or other designated places for shoppers. Shoppers rent the marCart to bring inside of the store. Shoppers may be able to acquire it from either a docking station where it can be rented. The marCart can also be purchased from retail stores/manufactures. Inside the store it is pushed or rolled by human or battery power. The marCart can be hauled from behind any vehicle when leaving the store. Shoppers Scan each item using the marCart scanner then place them inside the marCart. When shopping is completed, shoppers then proceed to the store's marCart Wireless Self Checkout Register. The store's marCart Wireless Self Checkout Register has a security check out mechanism to disable the mobility of the marCart, making it immobile until the check out process is completed. The marCart also visually and audibly alerts store loss prevention staffs/security, should a shopper not complete the check out process while the marCart is still mobile and attempt to leave the store without paying. A receipt is produced by the marCart Self Checkout Register to show at exits upon request.
